(19) United States
(12) Patent Application Publication
(10) Pub. No.: US 2015/0217415 A1
(43) Pub. Date: Aug. 6, 2015

(54) METHOD FOR REPAIRING A TURBOMACHINE COMPONENT

(71) Applicant: Nuovo Pignone Srl, Florence (IT)

(72) Inventors: Alessio Andolfi, Florence (IT); Federico Pineschi, Florence (IT); Giovanni Vitale, Florence (IT); Eugenio Giorni, Florence (IT); Attilio Paolucci, Florence (IT); Fabrizio Mammoliti, Florence (IT); Riccardo Catastini, Florence (IT)

(73) Assignee: Nuovo Pignone Srl, Florence (IT)

(21) Appl. No.: 14/426,434

(22) PCT Filed: Sep. 3, 2013
(86) PCT No.: PCT/EP13/68162

§ 371 Date: Mar. 6, 2015

(30) Foreign Application Priority Data
Sep. 7, 2012 (IT) CO2012A000040

(51) Int. Cl. B23P 6/00; F01D 5/00; B23K 26/00

(52) U.S. Cl. CPC B23P 6/007; B23K 26/0051; F01D 5/005

(57) ABSTRACT

A method for repairing a turbomachine component comprises the steps of: setting up a laser cladding machine including a laser source a powder feeder and an air source, for repairing a narrow recess of the turbomachine component; defining a path including areas to be repaired by laser cladding within the narrow recess; moving forward the laser cladding machine or the turbomachine component, in order that said path is covered from the first to the second end point by the laser beam and the powder jet for repairing said areas to be repaired; moving backward the laser cladding machine or the turbomachine component, in order that said path is covered from the second to the first end point by the air jet for blowing away the powder in excess.

### BACKGROUND OF THE INVENTION

The present invention relates to method and a machine for repairing a turbomachine component by laser-cladding. Particularly, albeit nor exclusively, the present invention is usable for repairing g stator cases of turbomachines by laser cladding.

The increasing use of turbomachines to the operational limits requires the development of specific repair technologies designed to reproduce conditions close to those of new parts. Both rotating and non-rotating parts are subject to damages due to erosion and/or to wear.

For example, steam turbine shafts are often damaged in coupling areas at shaft ends and in journal bearing areas. On centrifugal compressor shafts the same situation occurs for bearing journals and for the shaft ends, while very often during compressor overhaul; impellers are found with the sealing area worn out. Other rotary or stationary parts can be damaged as well, such as steam turbine blades, centrifugal compressor cases, or gas turbine rotors. In stator cases, for example stator cases of steam turbines, having stator blades, areas close to the blades are particularly difficult to be accessed. When traditional repairing techniques are used, the removal of stator blades is normally required before repairing.

In the above field, conventional repairing techniques, such as electric arc or microplasm deposit welding, show a plurality of disadvantages, i.e., in particular, high heating and cooling rates and low melting volumes. As an alternative, repairing methods by laser surfacing are known. Advantages of the latter over alternative surfacing processes include:

Chemically cleanliness, as combustion or ion bombardment are not involved,

Localized heating with minimum heat transfer to the substrate, resulting in minimal thermal damage for the component,

Reduced post-machining procedures,

Possibility to process very hard, brittle, or soft materials,

Possibility to control heat penetration,

Possibility to deposit thicker layers.

Among laser surfacing methods, laser cladding is generally known. Laser cladding uses a laser beam to fuse a cladding material having desired properties into the base material of a component whose surface is to be repaired. Laser cladding offers the possibility to create surface layers with superior properties in terms of pureness, homogeneity, hardness, bonding, and microstructure.

Laser cladding repairing methods are already used to repair stationary components, as described in US20100287754, or to deposit small volumes of cladding material, as described in US20090057275.

When repairing stator cases, and in particular when repairing areas close to stator blades laser cladding is particularly challenging for the necessity of providing a laser beam having a length suitable for reaching such a narrow recess. In addition, the cladding powder in excess, which is not fused to the base materiel of the component, would require to be conveniently removed after the repairing process. For the above reasons, in such cases laser cladding is not used or blades are removed before repairing the damaged areas.

It would be therefore desirable to provide an improved laser cladding method and machine which permits to avoid such inconveniencies of the known prior arts, in a fast and reproducible way for each turbomachine component to be repaired and in particular for turbomachine components having narrow recesses, for example stator cases with stator blades.

### SUMMARY

According to a first embodiment, the present invention accomplishes such an object by providing a method for repairing a turbomachine component comprising the steps of:

setting up a laser cladding machine including a laser source a powder feeder and an air source, the laser cladding machine being configured in such a way that a laser beam, a powder jet and an air jet, respectively generated by the laser source, the powder feeder and the air source, converge on an area to be repaired within a narrow recess of said turbomachine component;

defining a path including areas to be repaired by laser cladding within said narrow recess, said path being extended between a first end point and a second end point;

moving forward one of the laser cladding machine and the turbomachine component relatively to the other of the laser cladding machine and the turbomachine component, in order that said path is covered from the first to the second end point by the laser beam and the powder jet for repairing said areas to be repaired;

moving backward one of the laser cladding machine and the turbomachine component relatively to the other of the laser cladding machine and the turbomachine component, in order that said path is covered from the second to the first end point by the air jet for blowing away the powder in excess from said recess.

With respect to other known repairing methods, the solution of the present invention allows to repair more quickly and efficiently turbomachine component having narrow recesses subject to damaging and/or wear and/or corrosion and which need therefore to be repaired by a surfacing layering method. In particular, in repairing a stator case having stator blades, the latter do not need to be removed. The use of a laser cladding process permits to efficiently rebuild greater damaged volume, by depositing layers of greater thickness, without diminishing the mechanical properties of the repaired component.

According to a further advantageous feature of the first embodiment, the cladding path is an angular path, whose end points are spaced from one another of 180°. This allows applying the method of the present invention for quickly and efficiently repairing the halves of a stator case.

In a second embodiment, the present invention provides a laser cladding machine including a laser source a powder feeder and an air source (4), the laser cladding machine being configured in such a way that a laser beam, a powder jet and an air jet, respectively generated by the laser source, the powder feeder and the air source, converge on a same area.

The same advantages described above with reference to the first embodiment of the present invention are accomplished by this second embodiment.

### BRIEF DESCRIPTION OF THE DRAWINGS

Other object feature and advantages of the present invention will become evident from the following description of the embodiments of the invention taken in conjunction with the following drawings, wherein:

FIG. 1 is a general block diagram of a method for repairing a turbomachine, according to the present invention;

FIG. 2 is a prospect view of a laser cladding machine according to the present invention;

FIG. 3 are a detailed prospect view of the laser cladding machine in FIG. 2; and

FIG. 4 is a schematic view of essential components of the the laser cladding machine in FIG. 2.

### DETAILED DESCRIPTION OF THE INVENTION

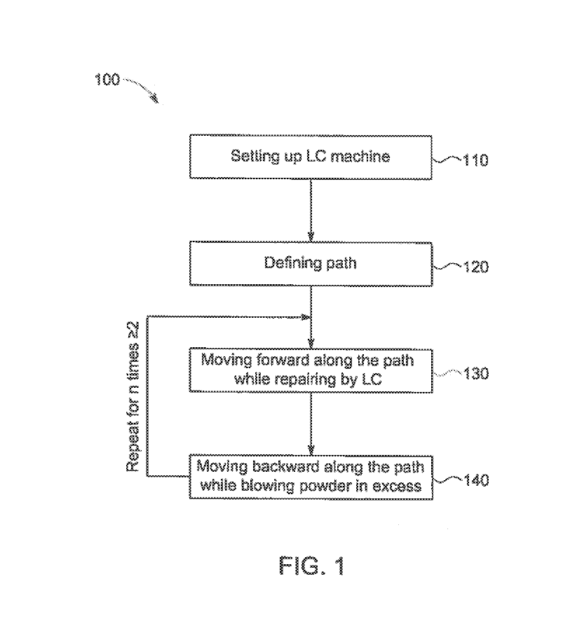

With reference to the attached FIG. 1, a method for repairing a turbomachine component C is overall indicated with 100.

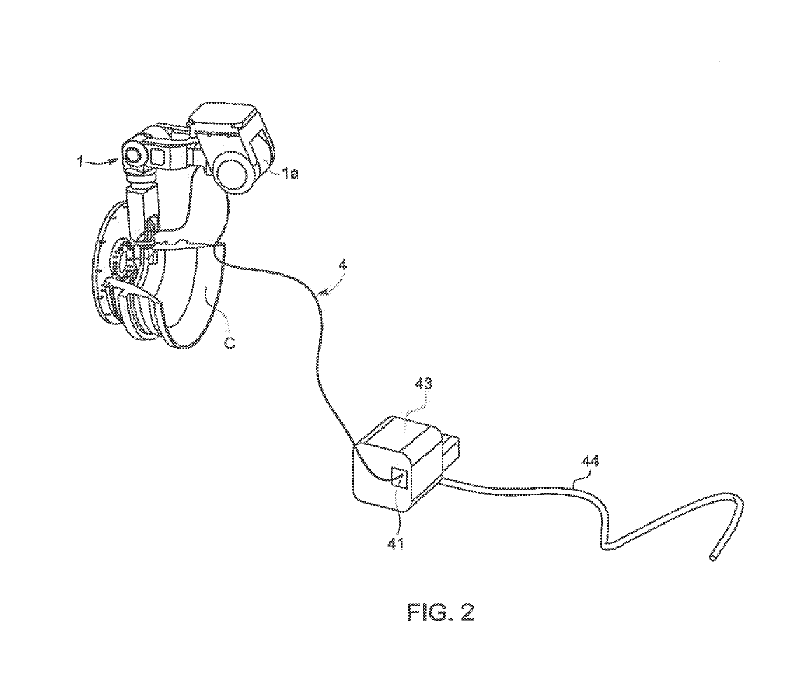

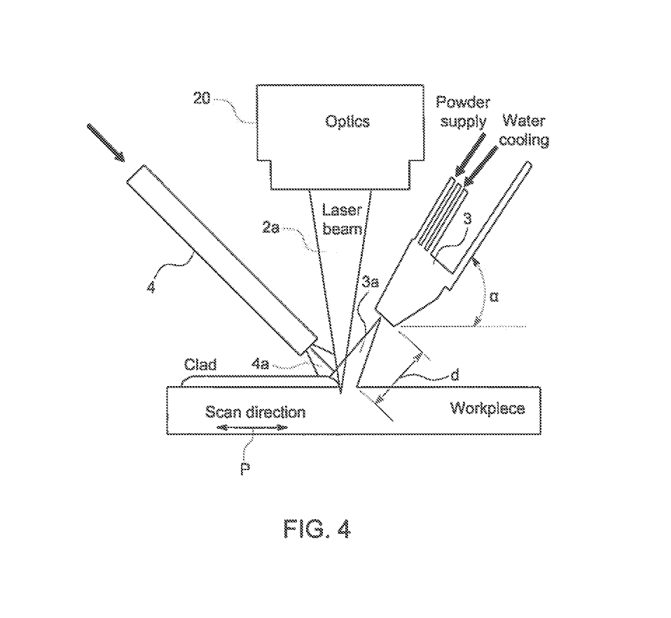

With reference to the attached FIGS. 2-4, a laser cladding machine for repairing a turbomachine component C is overall indicated with 1.

The method 1 comprises a first step 110 of setting up a laser cladding machine 1 including a laser source 2, a powder feeder 3 and an air source 4. The laser source 2 and the powder feeder 3 are mounted on a robotic arm 1a of the laser cladding machine 1.

The laser cladding machine 1 is configured in such a way that a laser beam 2a, a powder jet 3a and an air jet 4a are respectively generated by the laser source 2, the powder feeder 3 and the air source 4, converging on an area to be repaired within a narrow recess of the turbomachine component C. The laser source 2 includes an optical device 20 for directing the laser beam 2a towards the area to be repaired. In respective embodiments of the present invention, the focal length of the optical device 20 is conveniently chosen in order that the laser beam 2a generated by the laser source 2 has a convenient length, which permits to reach narrow recesses of the turbomachine component C.

The powder feeder 3 includes an off-axis nozzle 30, i.e. a nozzle generating a powder jet 3a which is not coaxial with the laser beam 2a. The nozzle 30 is provided at the end of an elongated flange 31 in such a way that the powder jet 3a can be conveniently directed towards the area to be repaired within a narrow recess of the turbomachine component C. The air source 4 includes a flexible tube 40 extending from an inlet section 41 to an outlet section 42. The flexible tube 40 is attached to the robotic arm 1a in such a way that the outlet section 42 is positioned in close proximity to the nozzle 30, in order to direct the air jet 4a towards the area to be repaired. The geometrical arrangement of the optical device 20, of the elongated flange 31 and of the terminal portion of the flexible tube 40 comprising the outlet section 42 permit to converge the laser beam 2a, a powder jet 3a and an air jet 4a on the area to be repaired. The inlet section 41 of the flexible tube 40 is connected to a volumetric compressor 43 for generating an air flow through the flexible tube 40 in order to produce the air jet 4a through the outlet section 42. The air source 4 further comprises a second tube 44 for providing air to the volumetric compressor 43 and a heat exchanger (not represented) for heating the air reaching the outlet section 42. Temperature of the air jet 4a has to be sufficiently high but in any case significantly lower than the tempering temperature of the material of the component C, in order not to modify the mechanical properties and structure of the repaired areas. For example, if component C is made of a low-alloy steel temperature of the air jet is, in an embodiment, comprised between 200° C. and 250° C.

In the embodiment of the attached FIGS. 2-4, the turbomachine component C is a steam turbine stator case comprising two shells 10 (only one shell 10 is represented in the attached figures, the other being identical), each shell 10 corresponding to a respective half portion of the stator case C. Method 1 is suitable for repairing areas which are damaged due to erosion and/or to wear along the inner surfaces of the shell 10, in particular areas close to the stator blades 11, for example areas in the narrow recess 12 between two adjacent rows of stator blades where a corresponding impeller of the steam turbines is housed.

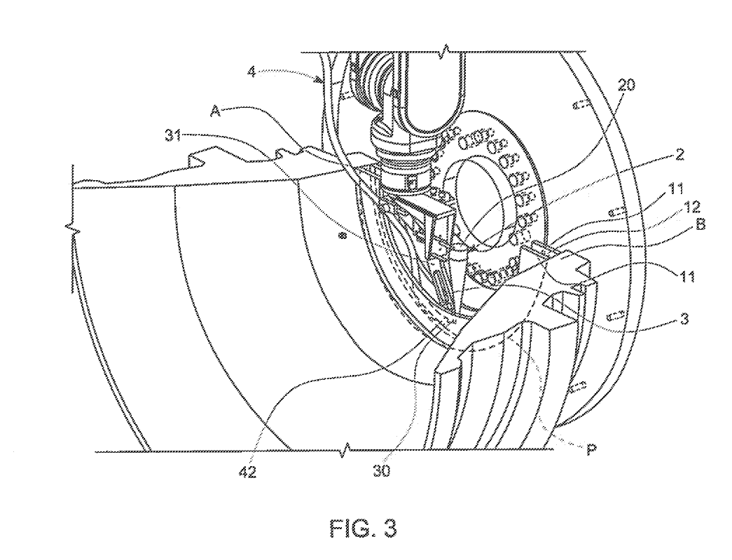

It is to be noted that the plurality of distinct and separated stator blades 11 are shown as a single piece in FIG. 3 only for simplifying the figure

After the first step 110, the method 100 includes a second step 120 of defining a linear or angular path P including areas to be repaired by laser cladding within the narrow recess. The path extends between a first end point A and a second end point B. In the embodiment of the attached FIGS. 2-4, the path P is angular and corresponds to half a circumference, the angular distance between the first end point A and the second end point B being 180°.

Before repairing the damaged area a plurality of process parameters of the laser cladding machine 1 have to be defined. The process parameters include:

powder rate,

laser beam power,

scanning speed,

stand-off distance (i.e. distance between the nozzle of the powder feeder 3 and the areas to be repaired),

cover gas flow rate,

powder mesh,

energy density,

focal length of the optical device 20 of the laser source 2,

angle between the laser beam 2a and the path P.

Some of the above parameters depend from the geometry of the component C. In particular, when repairing areas in narrow recesses the focal length must be conveniently high in order that the laser beam 2a reaches the area to be repaired along the path P. Given the above geometrical constrain, all the other parameters have to be conveniently defined in order to efficiently repair the damaged areas of the component C. The tuning of the above parameters is however not a specific object of the present invention.

The method further includes a preliminary step of machining the area to be repaired along the path P, in order to create an even surface on which laser cladding will be subsequently performed, as above described. In the embodiment of the attached FIGS. 2-4, the preliminary step of machining typically includes turning the area to be repaired by using a vertical lathe comprising a mandrel on which the shell 10 is mounted, according to a conventional and well-known in the art turning procedure.

After the above parameters have been defined, after the preliminary step of machining and after execution of the second step 120, the method 100 includes a third cladding step 130 of moving forward the laser cladding machine 1 or the turbomachine component C, one relatively to the other, in order that the path P is covered from the first to the second end point A, B by the laser beam 2a and the powder jet 3a for repairing the damaged areas to be repaired along the path P. In the embodiment of the attached FIGS. 2-4, the robotic arm 1a is moved along the circular path P from the first end point A to the second end point B in order that the path P is covered by the laser beam 2a and the powder jet 3a.

During the cladding process, only part of the cladding material, i.e. of the powder from the jet 3a is fused on the component C. Therefore, after the third step 130 has been performed, an excess of powder, which has not been fused in the component C by the cladding process, will remain along the path P. To remove such excess, after the third step 130, the method 100 includes a fourth cleaning step 140 of moving backward the laser cladding machine 1 or the turbomachine component C, one relatively to the other, in order that the path P is covered from the second to the first end point B, A by the air jet 4a for blowing away the powder in excess from the repaired areas in the recess. In the embodiment of the attached FIGS. 2-4, the robotic arm la is moved along the circular path P from the second end point B to the first end point A, in order that the path P is covered by air jet 4a.

According to the different embodiments of the present invention, to complete the repairing of the damaged areas along the path P, the third and the fourth step 130, 140 have to be repeated once or more than once, i.e. a total number of times n≧2, in order to apply at least two layers of cladding material. The number of repetitions n depends on the thickness of the layers of cladding material deposited at each execution of the third cladding step 130 and on the total amount of cladding material to be deposited to achieve perfect reparation along the path P.

According to some embodiments of the present invention, when repeating the third step 130 the angle between the laser beam 2a and the path P along the area to be repaired is changed. Typically in all cases such angle is lower or equal to 90°.

In general, many other turbomachine components can be repaired with the method of the present invention by using a laser cladding method and machine as above described.

In all cases it essential that third and the fourth step 130, 140 are repeated one after the other, respectively, in order to clean the repaired areas from the unfused cladding material after each execution of the third cladding step 130.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

What is claim is:

1. A method for repairing a turbomachine component, the method comprising:
setting up a laser cladding machine comprising a laser source, a powder feeder, and an air source, the laser cladding machine being configured in such a way that a laser beam, a powder jet, and an air jet, respectively generated by the laser source, the powder feeder, and the air source), converge on an area to be repaired within a narrow recess of the turbomachine component;
defining a path comprising areas to be repaired by laser cladding within the narrow recess, the path being extended between a first end point and a second end point;
moving forward one of the laser cladding machine and the turbomachine component relative to the other of the laser cladding machine and the turbomachine component, in order that the path is covered from the first end point to the second end point by the laser beam and the powder jet for repairing the areas to be repaired; and
moving backward one of the laser cladding machine and the turbomachine component relative to the other of the laser cladding machine and the turbomachine component, in order that the path is covered from the second end point to the first end point by the air jet for blowing away the powder in excess from the narrow recess.

2. The method according to claim 1, wherein moving forward and moving backward are repeated once or more than once.

3. The method according to claim 1, wherein the path is an angular path.

4. The method according to claim 1, wherein the first end point and the second end point are angularly spaced from one another of 180°.

5. The method according to claim 1, wherein the turbomachine component is a stator case.

6. A laser cladding machine, comprising:
a laser source;
a powder feeder; and
an air source,
wherein the laser cladding machine is configured in such a way that a laser beam, a powder jet, and an air jet, respectively generated by the laser source, the powder feeder, and the air source, converge on a same area.

7. The laser cladding machine according to claim 6, wherein the laser cladding machine is further configured to:
repair areas within a narrow recess of a turbomachine component, wherein the narrow recess comprises a path comprising the areas, and the path extends between a first end point and a second end point,
move forward relative to the turbomachine component, in order that the path is covered from the first end point to the second end point by the laser beam and the powder jet for repairing the areas, and
move backward relative to the turbomachine component, in order that the path is covered from the second end point to the first end point by the air jet for blowing away the powder in excess from the narrow recess.

8. The laser cladding machine according to claim 7, wherein the laser cladding machine is further configured to repeatedly move forward and move backward at least once.

9. The laser cladding machine according to claim 7, wherein the path is an angular path.

10. The laser cladding machine according to claim 7, wherein the first end point and the second end point are angularly spaced from one another of 180°.

11. The laser cladding machine according to claim 7, wherein the turbomachine component is a stator case.
